(19) United States
(12) Patent Application Publication
(10) Pub. No.: US 2003/0210483 A1
(43) Pub. Date: Nov. 13, 2003

(54) Method and apparatus for constructing a perfect trough parabolic reflector

(76) Inventor: Greg J. Wright, Flower Mound, TX (US)

Correspondence Address: John E. Vandigriff, Suite 200, 190 N. Stemmons Frwy., Lewisville, TX, 75067, US

(21) Appl. No.: 10/425,117

(22) Filed: Apr. 29, 2003

Related U.S. Application Data
(60) Provisional application No. 60/378,596, filed on May 7, 2002.

(51) Int. Cl. G02B 7/182

(52) U.S. Cl. 359/871

(57) ABSTRACT

A boundary box and a coordinate system define the length of the curve of a parabola used in constructing a parabolic trough reflector. The origin(0,0) of the coordinate system is at the top center of the boundary box. The two lower corners of the boundary box define the width, height of the parabola. These points are defined as (X1,Y1)=(−width,−height), and (X2,Y2)=(width, height). The equation defining the parabola is f(x)=a·x², where a=−height/width². The plot of this equation produces a parabola that fits into the boundary box, and touches the bounding box points. Within the box, two small blocks are used as anchor points for the end of the parabola. The length of the curve of the parabola is defined in the equation: length(x)=

$$length ( x ) = a \cdot [ X ( \sqrt{{X}^{2} + {b}^{2}} ) + {b}^{2} \cdot ln ( X + \sqrt{{X}^{2} + {b}^{2}} ) ] ,$$

where b=1/2·a.

### PRIORITY

Priority is based upon Provisional Application No. 60/378,596, filed May 7, 2002.

### FIELD OF THE INVENTION

The invention relates to parabolic reflectors, and more particularly to a method and apparatus for construction a parabolic reflector from a flexible material.

### BACKGROUND OF THE INVENTION

Parabolic reflectors can be constructed by shaping a flexible material to the parabolic shape. This may be accomplished by bending the flexible material to form a parabola. In some instances, the parabola may be formed by molding the material to the parabolic shape and coating it with a suitable material.

In U.S. Pat. No. 4,115,177, a tool is provided for manufacturing parabolic solar reflectors. The tool employs an improved smooth convex parabolic surface terminating in edges remote from the parabolic vertex which are preferably placed under elastic tension tending to draw the edges toward each other. The improved convex surface is a film of plastic coated with chromium metal on its exterior surface. A multiple layered thermosetting plastic reflector support is molded onto the convex surface of the tool. The reflector support is removed from the tool and a layer of aluminum is vacuum deposited onto the interior concave parabolic reflector surface.

In U.S. Pat. No. 4,571,812, a solar concentrator of substantially parabolic shape is formed by preforming a sheet of highly reflective material into an arcuate section having opposed longitudinal edges and having a predetermined radius of curvature and applying a force to at least one of the opposed edges of the section to move the edges toward each other and into a predetermined substantially parabolic configuration and then supporting it.

A parabolic trough solar collector using reflective flexible materials is disclosed in U.S. Pat. No. 4,493,313. A parabolic cylinder mirror is formed by stretching a flexible reflecting material between two parabolic end formers. The formers are held in place by a spreader bar. The resulting mirror is made to track the sun, focusing the sun's rays on a receiver tube. The ends of the reflective material are attached by glue or other suitable means to attachment straps. The flexible mirror is then attached to the formers. The attachment straps are mounted in brackets and tensioned by tightening associated nuts on the ends of the attachment straps. This serves both to stretch the flexible material orthogonal to the receiver tube and to hold the flexible material on the formers. The flexible mirror is stretched in the direction of the receiver tube by adjusting tensioning nuts. If materials with matching coefficients of expansion for temperature and humidity have been chosen, for example, aluminum foil for the flexible mirror and aluminum for the spreader bar, the mirror will stay in adjustment through temperature and humidity excursions. With dissimilar materials, e.g., aluminized mylar or other polymeric material and steel, spacers can be replaced with springs to maintain proper adjustment. The spreader bar cross section is chosen to be in the optic shadow of the receiver tube when tracking and not to intercept rays of the sun that would otherwise reach the receiver tube. This invention can also be used to make non-parabolic mirrors for other apparatus and applications.

In U.S. Pat. No. 4,348,798, an extended width parabolic trough solar collector is supported from pylons. A collector is formed from a center module and two wing modules are joined together along abutting edges by connecting means. A stressed skin monocoque construction is used for each of the modules.

In U.S. Pat. No. 4,135,493, a parabolic trough solar energy collector including an elongated support with a plurality of ribs secured thereto and extending outwardly therefrom. One surface of said ribs is shaped to define a parabola and is adapted to receive and support a thin reflecting sheet which forms a parabolic trough reflecting surface. One or more of said collectors are adapted to be joined end to end and supported for joint rotation to track the sun. A common drive system rotates the reflectors to track the sun; the reflector concentrates and focuses the energy along a focal line. The fluid to be heated is presented along the focal line in a suitable pipe which extends therealong.

### SUMMARY OF THE INVENTION

In the present invention, a boundary box and a coordinate system are defined such that the origin (0,0) of the coordinate system is at the top center of the boundary box. Two small rectangular anchor blocks, with predefined slits, at the two lower corners of the boundary box define the width and height of the parabola. These points are defined as (X1,Y1)=(−width,−height), and (X2,Y2)=(width, height). The equation defining the parabola is f(x)=a·x², where a=−height/width². The plot of this equation will produce a parabola that fits into the bounding box, and touches the bounding box points (0,0), (X1,Y1) and (X2,Y2). Within the box, two small blocks are used as anchor points for the ends of the parabola.

### BRIEF DESCRIPTION OF THE DRAWINGS

FIG. 1 shows the boundary box and the calculated points to form the parabola; and

FIG. 2 shows a parabola in a frame representative of the present invention.

### DESCRIPTION OF A PREFERRED EMBODIMENT

One basic method for Creating a Perfect Parabolic Trough Reflector can be defined in several steps as set forth below.

(1) First the height and width of the parabola to be built is determined.

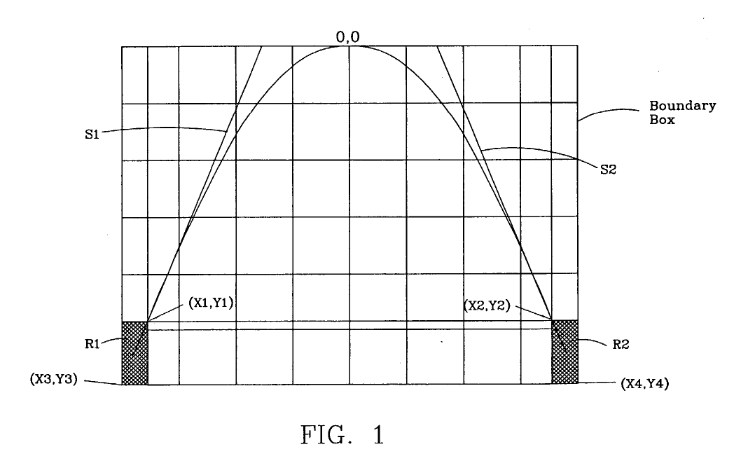

(2) A boundary box (see FIG. 1) is defined, and a coordinate system such that the origin (0,0) is at the top dead center of the boundary box. The coordinates (−width,−height) and (width,−height) are defined near the two lower corners of the box. As shown in FIG. 1, and hereinafter (X1,Y1)=(−width,−height) and (X2,Y2)=(width,−height).

(3) The parabolic equation is defined to be f(x)=a·x² where a=−height/width². The plot of this equation will produce a parabola that fits into the bounding box and touches the bounding box at the points (0,0), (X1,Y1), (X2,Y2) and at no other point.

(4) The points (X3,Y3) and (X4,Y4) are defined to be at the opposite corners of the two smaller rectangles R1,R2 from the respective points (X1,Y1) and (X2,Y2) as shown in FIG. 1. The two small rectangles R1,R2 are the anchor points of the parabola at its end points. The third anchor point (0,0) is at the origin. The dimensions of the boundary box are therefore (X4−X3) and (−Y4).

(5) The lines (indicated as S1,S2) at the lower anchor points are a plot of the lines that have a slope of the 1st derivatives of the parabola at the points (X1,Y1) and (X2,Y2) and intercept these points.

(6) The slots (also identified as S1, S2, and defined as the lines in (5) above) in the blocks R1,R2 are used to anchor the parabola. Slots S1,S2 must have the slope of the lines in step (5), touch the points (X1,Y1) and (X2,Y2) respectively, and extend into the blocks for a sufficient distance to allow the material used to form the parabola to be anchored. The width of the slots should match the width of the reflective material. In addition, the point (0,0) must be anchored to the top dead center of the bounding box and the 1st derivative of the curve at this point must be 0. The ends of the parabola in slots S1 and S2, and the top center (0,0) may be anchored, for example, by screws or clamps.

(7) The length of the curve of the parabola is calculated as: length

$$length ( x ) = a \cdot [ X ( \sqrt{{X}^{2} + {b}^{2}} ) + {b}^{2} \cdot ln ( X + \sqrt{{X}^{2} + {b}^{2}} ) ] .$$

In the formula, “a” is the coefficient of the parabola defined in step (3), and “b”=1/(2·a). The length of the parabolic curve from the point (X1,Y1) to the point (X2,Y2) is length(X2)−length(X1). To this is added the length of material that extends into both slots S1,S2. Both anchor blocks R1,R2 are mirror images of each other so the slots at both points are of the same length. This means only one kind of anchor block has to be built. However, mathematically this does not have to be so, as long as the calculations are done correctly to compensate for slots of different lengths.

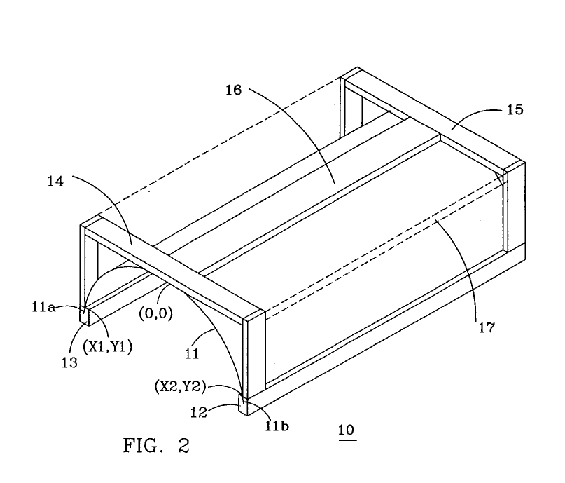

(8) Once the calculations have been performed, a suitable ridged support structure is constructed (see FIG. 2, discussed below) to hold the points (0,0), (X1,Y1), (X2,Y2) of the parabola, and their 1st derivatives in their proper places. To insure a slope of 0 at the origin of the coordinate system, the center of the length of the reflective material from points (X1,Y1) to (X2,Y2) is anchored at the origin by, for example, a screw, a rivet, or by some other means. The symmetry of the bending forces of the material will cause the 1st derivative of the origin to be 0 as required. Each side of the rectangular piece of reflective material must be supported in this way. The two sides of the support structure are joined by suitable means to form a parabolic trough. The material used for the reflector should be of the same thickness throughout, and must be homogeneous. In addition, the strength of the material must be strong enough to hold the shape of the parabolic reflector.

FIG. 2 shows an embodiment 10 of a Perfect Parabolic Trough Reflector. The parabola 11 has its edges 11a and 11b in slots in supports 12 and 13. The portions of the parabola 11 in supports 12 and 13 are the 1st derivatives extending from the parabola 11. The supports 12 and 13 are attached to additional supports 14 and 15. The supports 12, 13,14 and 15, along with top support 16, forms the boundary box, as discussed above, that provides the means for forming and supporting the parabola.

In FIG. 2, the boundary box support may have a larger back support 17 (in dotted lines) in place of the support 16. Back support 17 would provide additional support and a larger support for mounting the parabola. The top of the parabola, the portion under support 16, is attached to support 16, or support 17. This is the (0,0) point of the parabola, as discussed above. The points,(X1,Y1) and (X2,Y2) of the parabola are show in FIG. 2.

The support structure in FIG. 2 is show as an example. Other support structures may be used.

What is claimed:

1. A method for constructing a parabolic trough reflector, comprising the steps of:
defining a boundary box;
calculating the dimension of, including the length of the curve of the parabola, and making a parabolic trough reflector that fits into the boundary box;
forming a support structure as defined by the boundary box; and securing the parabolic trough reflector in the support structure.

2. The method according to claim 1, wherein the length of the curve of the parabola is defined as:
$$length ( x ) = a \cdot [ X ( \sqrt{{X}^{2} + {b}^{2}} ) + {b}^{2} \cdot ln ( X + \sqrt{{X}^{2} + {b}^{2}} ) ] .$$

3. The method according to claim 1, wherein the securing of the parabolic trough reflector in the boundary box is done on at least three points along the length of the curve of the parabola.

4. The method according to claim 1, wherein each end of the length of the parabola trough is secured in a mathematically precise slot in the support structure.

5. A method for constructing a parabolic trough reflector, comprising the steps of:
defining a boundary box;
calculating the dimension of, including the length of the curve of the parabola, and making a parabolic trough reflector that fits into the boundary box;
forming a support structure as defined by the boundary box; and securing the parabolic trough reflector in the support structure on at least at three points along the length of the curve of the parabola.

6. A parabolic trough reflector, comprising:
a boundary box defining the length of the curve of the parabola; and
a parabolic trough reflector mounted in the boundary box.

7. The parabolic trough reflector according to claim 6, wherein the parabolic trough reflector is secured to the boundary box on at least three points along the length of the curve of the parabola.

8. The parabolic trough reflector according to claim 6, wherein the boundary box includes a structure for mounting the parabolic trough reflector.
